(19) United States
(12) Patent Application Publication
(10) Pub. No.: US 2016/0111079 A1
(43) Pub. Date: Apr. 21, 2016

(54) DEVICE FOR HEARING OWN VOICE

(71) Applicant: John H. Schmucker, Fort Wayne, IN (US)

(72) Inventor: John H. Schmucker, Fort Wayne, IN (US)

(21) Appl. No.: 14/984,276

(22) Filed: Dec. 30, 2015

Related U.S. Application Data
(63) Continuation of application No. 14/301,637, filed on Jun. 11, 2014.

(51) Int. Cl. G10K 11/22

(52) U.S. Cl. CPC G10K 11/22

(57) ABSTRACT

An apparatus for assisting a vocalist to hear the vocalist's own voice has a mixing chamber defining a first passage for communicating with an ear canal of a vocalist and an opening that is open to atmosphere. The mixing chamber includes a ball and socket joint having a passage in communication with the first passage. An ear piece is connected to the ball and socket joint and has a passage in communication with the first passage. A stabilizing ear retainer shaped to engage the outer ear of the vocalist is connected to the mixing chamber and mounts and retains the apparatus to the vocalist's ear. A voice tube is configured to extend from proximate a mouth of the vocalist and is connected to the mixing chamber. The voice tube defines a passage having an opening for collecting vocal sound from the vocalist an opening in communication with the first passage.

### CROSS-REFERENCE TO RELATED APPLICATIONS

The present application is a continuation of U.S. patent application Ser. No. 14/301,637, filed Jun. 11, 2014, the contents of which are hereby incorporated by reference in their entirety into this disclosure.

### TECHNICAL FIELD

The present invention relates to devices for assisting vocalists to hear their own voice and, more particularly, to acoustic devices for guiding sound from the vicinity of the vocalist's mouth to the vocalist's ear canal, for example, when singing.

### BACKGROUND

The related art includes various acoustic devices for guiding sound from a vocalist's mouth to his or her ear canal.

Monnie et al, U.S. Pat. No. 7,356,155, shows a device for assisting vocalists in hearing their own voice. The device includes a sound receiver section for placing in front of one's mouth. Sound receiving section is in communication with a sound director section which, in turn, is in communication with a sound delivering section placed over one's ear. The device includes means for lengthening the sound director section.

Schaefer II, U.S. Pat. No. 3,182,746, shows a one piece voice box for aural training. The voice box or mouthpiece communicates with the earpiece through a connecting section. An opening is provided through a portion adjacent the earpiece. A valve is fitted in an opening for use by a teacher or others to speak to the user while the device is being used.

Rasmussen, U.S. Pat. No. 1,494,019, shows a “cantaphone” for aiding vocal students, singers and speakers to develop their voice. The cantaphone includes a hollow member in communication with a flexible transmitting tube which extends to the headphone ear pieces.

Gerwick, U.S. Pat. No. 3,259,204, shows a sound reflecting device for speech practice. The device includes a mask adapted to be worn over one's mouth. Flexible tubes extend from within the mask and include ear plugs at their terminal ends adapted for insertion into the ears of the user.

Green, D 423,103, shows a speech and hearing therapy device which is essentially a contiguous tube extending from one's mouth to one's ear.

Morimoto, D 377,098: Cousino, D 189,450; and Mickelson et al., U.S. Pat. No. 6,229,901, show devices including headphones and means for reflecting one's voice to both ears.

It would be desirable to provide an improved device for guiding vocal sounds from one's mouth to one's ear to assist in hearing one's own voice that ameliorates the risk of excessive loudness and, further, is adjustable and easy to use. This and other desirable advantages are obtained by the present invention.

### SUMMARY

In accordance with one aspect of the present invention, an apparatus for assisting a vocalist to hear the vocalist's own voice includes a mixing chamber defining a first passage having a first opening for communicating with an ear canal of a vocalist and a second opening that is open to atmosphere. A voice tube is configured to extend from proximate a mouth of the vocalist and is connected to the mixing chamber, the voice tube defining a second passage having a third opening for collecting vocal sound from the vocalist and a fourth opening in communication with the first passage.

Preferably, a blocking surface is provided in the mixing chamber first passage configured to partially occlude sound from said mixing chamber second opening and the blocking surface is formed by the voice tube extending into the mixing chamber first passage. The voice tube can include an angled end defining the fourth opening whereby the vocal sound is directed toward the ear canal of the vocalist, and the angled end can includes a blocking surface for partially occluding said first passage. The mixing chamber can include a ball-and-socket joint between the mixing chamber first and second openings, and wherein the ball and socket joint defines a third passage therethrough in communication with said first passage. A stabilizing ear retainer is secured to the mixing chamber and shaped to engage the outer ear of the vocalist to mount and retain the apparatus to the vocalist's ear. The voice tube can include first and second portions which are frictionally engaged telescopically in longitudinal sliding relationship and in rotational relationship. A spring clip can be disposed between inner and outer walls respectively of the first and second portions in frictional engagement therewith.

In another form thereof, the present invention is directed to an apparatus for assisting a vocalist to hear the vocalist's own voice including a sound directing chamber defining a first passage having a first opening for communicating with an ear canal of a vocalist. A voice tube is provided and configured to extend from proximate a mouth of the vocalist and connected to the sound directing chamber. The voice tube defines a second passage having a third opening for collecting vocal sound from the vocalist and a fourth opening in communication with the first passage. The sound directing chamber includes a ball-and-socket joint between its first passage and its first opening. The ball and socket joint defines a third passage therethrough in communication with the first passage.

In yet another form thereof, the present invention is directed to an apparatus for assisting a vocalist to hear the vocalist's own voice including a sound directing chamber defining a first passage having a first opening for communicating with an ear canal of a vocalist. A voice tube is provided and configured to extend from proximate a mouth of the vocalist and connected to the sound directing chamber. The voice tube defines a second passage having a third opening for collecting vocal sound from the vocalist and a fourth opening in communication with the first passage. The voice tube includes first and second portions telescopically engaged in both longitudinal sliding relationship and in rotational relationship.

### BRIEF DESCRIPTION OF THE DRAWINGS

The above mentioned and other features of this invention, and the manner of attaining them, will become more apparent and the invention itself will be better understood by reference to the following description of embodiments of the invention taken in conjunction with the accompanying drawings, wherein:

FIG. 1 is a perspective view of an exemplary embodiment of an apparatus in accordance with the present invention mounted to the ear of a vocalist and shown in a front facial view of the vocalist.

FIG. 2 is a side view of the apparatus of FIG. 1 mounted to the ear of a vocalist and shown in a side facial view of the vocalist.

FIG. 3 is a top view of the apparatus of FIG. 1.

FIG. 4 is a side view of the apparatus of FIG. 1.

FIG. 5 is a front view of the apparatus of FIG. 1.

FIG. 6 is an exploded view of the apparatus of FIG. 1 oriented as in the top view of FIG. 3.

FIG. 7 is a longitudinal section view of the apparatus of FIG. 1 taken in section plane 7-7 of FIG. 4 and viewed in the direction of the arrows.

FIG. 8 is a cross-sectional view of the apparatus of FIG. 1 taken in section plane 8-8 of FIG. 3 and viewed in the direction of the arrows.

Corresponding reference characters indicate corresponding parts throughout the several views. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION OF THE ILLUSTRATIVE EMBODIMENTS

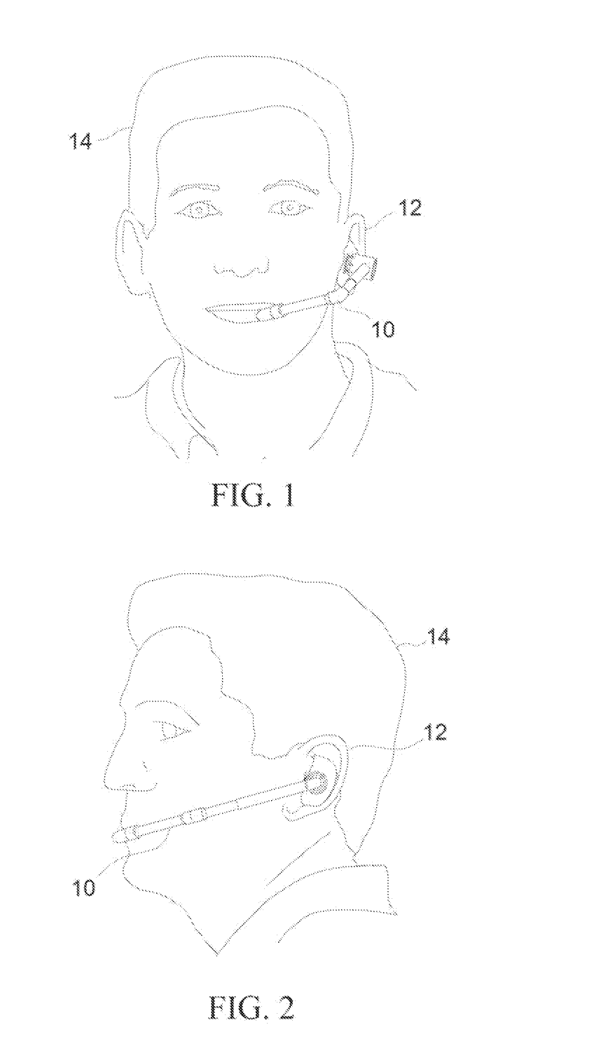

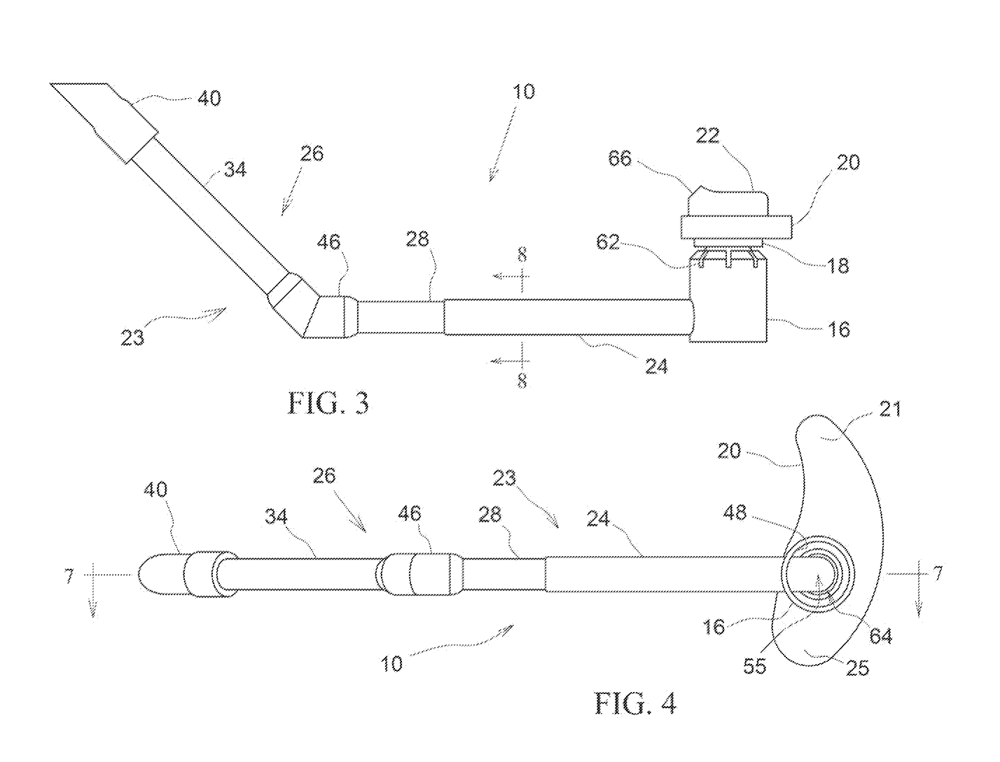

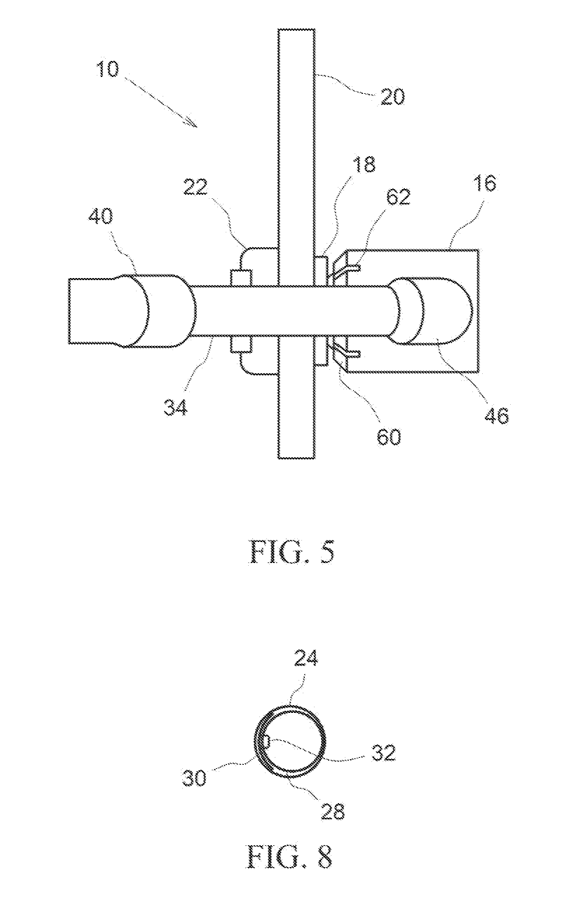

Referring to FIGS. 1-2, an exemplary embodiment of the present invention is illustrated as a device 10 mounted to an ear 12 of a vocalist 14 for assisting the vocalist to accurately hear his own voice. Device 10 can, for example, be used for hearing one one's voice while singing. The device 10 is shown in greater detail in FIGS. 3-8.

In FIGS. 3-8, device 10 is illustrated as including a mixing or sound directing chamber 16, a swivel joint base 18, a stabilizing ear retainer 20, and an ear piece 22. Also included is a voice tube 23 having a hollow main tube 24 and an extension tube 26 including a first portion 28 that is telescopically received in main tube 24 in longitudinally sliding relationship therewith. First portion 28 is also disposed in rotational relationship with main tube 24 for rotation about the mutual longitudinal axis thereof relative to tube 24.

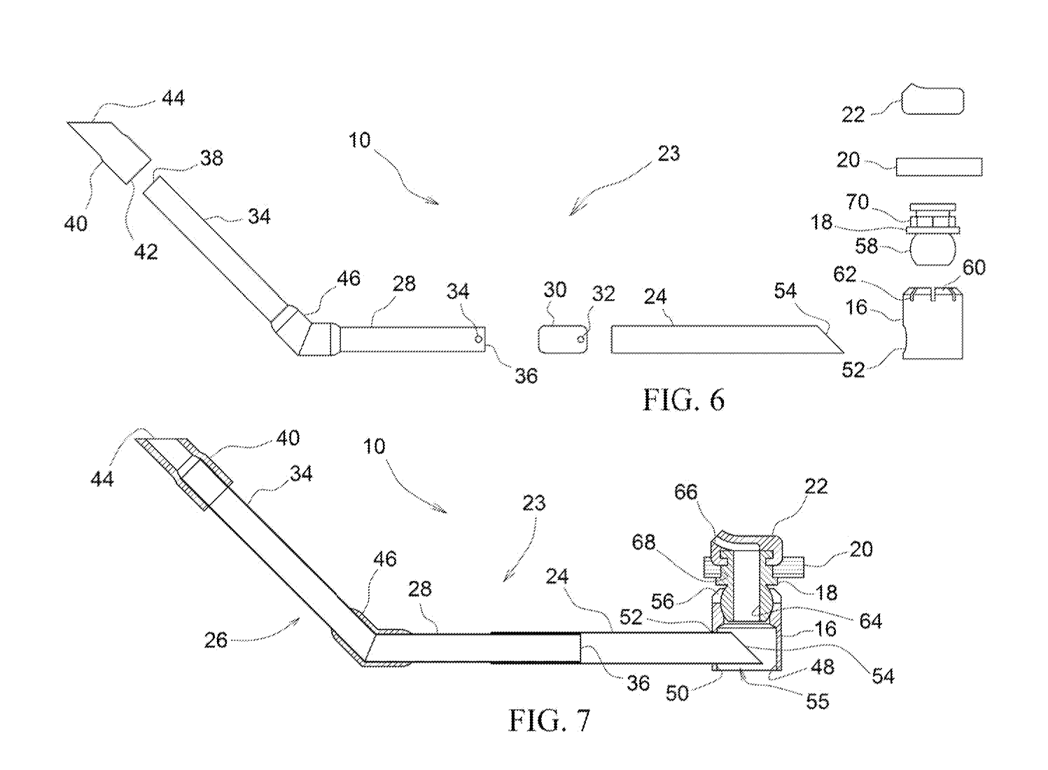

A friction clip 30 (FIGS. 6 and 8) is interposed between overlapping areas of first portion 28 of tube 26 and main tube 24. A protrusion 32 on clip 30 engages a hole 34 in a wall of first portion 28 to prevent clip 30 from sliding longitudinally and rotationally relative to first portion 28, whereas clip 30 slides in frictional engagement with the inside of the wall of main tube 24. Clip 30 is curved to function as a spring acting against the outside of the wall of first portion 28 and against the inside of the wall of main tube 24 to provide sufficient friction to maintain first portion 28 and main tube 24 in a selected telescopic relationship and rotational relationship, while permitting adjustment of the amount of telescopic extension and rotation of first portion 28 relative to main tube 24.

Extension tube 26 also includes a second portion 34 disposed at an obtuse angle relative to first portion 28 and having a hollow interior passage in communication with the hollow interior passage of first portion 28. First portion 28 and second portion 34 of extension tube 26 are open at respective ends 36, 38 (FIG. 6), with both ends in communication with the hollow interior passages thereof. A voice collector 40 having a passage therethrough and open at ends 42, 44 is attached to the free end of second portion 34 with the passages of collector 40 and second portion 34 in communication. An over-molded plastic elbow 46 connects and holds together first and second portions 28 and 34 of extension tube 26.

Mixing chamber 16 includes a through passage 48 (FIG. 7) having an end 50 open to atmosphere. An opening 52 through a sidewall of mixing chamber 16 communicates with passage 48. Angled open end 54 of main tube 24 is received through and retained within opening 52 such that the hollow passage of tube 24 is in communication with passage 48 of mixing chamber 16. Main tube 24 extends into passage 48 and only partially occludes passage 48. Angled open end 54 is directed toward the passage 48 and end 56 of the mixing chamber, away from the open end 50. Tube 24 thereby forms a blocking surface 55 for partially occluding sound entering the passage 48 from open end 50 while directing the vocalist's voice from main tube 24 towards the vocalist's ear canal. Other structures for partially occluding passage 48 while directing the vocalist's voice towards the ear canal can be used such as, for example, a 90° elbow communicating with the passage of main tube 24 and being directed towards the end 56 of the mixing chamber. The angled opening 54 has, however, been found to be an inexpensive acceptable option.

End 56 of mixing chamber 16, opposite end 50, is open and receives therein a ball portion 58 of swivel joint base 18 in a swiveling, ball-and-socket relationship. A plurality of resilient fingers 60 separated by slots 62 are elastically deformable to permit ball portion 58 to be received and retained therebetween in a spherical cavity defined by mixing chamber 16. Swivel joint base 18, including ball portion 58, has a longitudinal passage 64 therethrough open at opposite ends and in communication with passage 48 of mixing chamber 16.

A resilient rubber ear piece 22 engages and is retained on swivel joint base 18 opposite ball portion 58. Ear piece 22 includes a passage 66 therethrough open at opposite ends and in communication with passage 64 of swivel joint base 18.

Disposed between, and retained by ear piece 22 and base 18, is foam rubber ear retainer 20. Base 18 passes through an aperture 68 in retainer 20. A polygonal or multi-pointed periphery of section 70 of base 18 frictionally engages aperture 68 to resist rotation of retainer 20 relative to base 18. Retainer 20 includes an upper thin end 21 and a lower wide end 25 adapted to conform to and better fit within a vocalist's outer ear 12. The retainer 20 of FIG. 4 is thereby adapted to fit within the vocalist's left ear. However, retainer 20 can be reversed by detaching the ear piece 22 and turning for thereby adapting to fit within the vocalist's right ear.

In use by a vocalist 14, device 10 is mounted to an ear 12 such that opening 66 of ear piece 22 is disposed in communication with the ear canal of the vocalist. Retainer 20 is shaped to be received within and engage the outer ear 12 such that device 10 is retained in mounted position at ear 12. The swiveling, ball-and-socket joint by which mixing chamber 16 is connected to joint base 18 permits main tube 24, along with mixing chamber 16, to be adjusted in three rotational dimensions relative to base 18 and retained in a selected orientation that facilitates placement of voice collector 40 in proximity to the mouth of the vocalist. The relative length of device 10 can be adjusted by sliding extension tube 26 longitudinally relative to main tube 24. Extension tube 26 can also be rotated relative to main tube 24.

The sound of the vocalist's voice is collected at opening 44, passes through the passage of collector 40 into the passages of tubes 26 and 24, and thence from open end 54 into passage 48 of mixing chamber 16. The sound of the vocalist's voice is mixed in passage 48 with ambient sound received through opening 50. The mixed sound passes through passage 64 of swivel base 18 and passage 66 of ear piece 22 and thence into the ear canal of the vocalist. The opening 50 of mixing chamber 16, which is open to atmosphere, also provides an escape for excessive sound wave pressure coming from voice collector 40, thereby ameliorating a risk of excessive loudness that might otherwise be caused by loud sound being channeled directly through a passage from the voice collector to the ear canal.

While this invention has been described as having an exemplary design, the present invention may be further modified within the spirit and scope of this disclosure. This application is therefore intended to cover any variations, uses, or adaptations of the invention using its general principles.

Claimed is:

1. A device for assisting a vocalist to hear his or her voice, comprising:
a mixing chamber defining a first opening and a second opening, the first opening for positioning relative to an ear of the vocalist and the second opening open to atmosphere; and
a voice tube extending from proximate a mouth of the vocalist to the mixing chamber and defining a third opening and a fourth opening, the third opening for positioning relative to the mouth and the fourth opening located relative to the mixing chamber.

2. The device of claim 1, wherein the voice tube comprises an extension tube at least partially inserted into a main tube.

3. The device of claim 2, wherein the extension tube is rotatable within the main tube.

4. The device of claim 2, further comprising:
a friction clip interposed between overlapping areas of the extension tube and the main tube.

5. The device of claim 4, wherein the friction clip slides in frictional engagement within the main tube.

6. The device of claim 2, further comprising:
a voice collector positioned at an end of the extension tube proximate the mouth of the vocalist.

7. The device of claim 2, wherein the extension tube frictionally engages the main tube.

8. The device of claim 1, wherein when a portion of the device is positioned relative to the ear of the vocalist and wherein when the third opening is positioned relative to the mouth of the vocalist, sound from the voice of the vocalist can travel through the third opening of the voice tube, through the voice tube to the mixing chamber, whereby the sound combines with ambient sound from the second opening within the mixing chamber to form a mixed sound, and whereby the mixed sound can travel from the mixing chamber out of the first opening and into an ear canal of the vocalist.

9. The device of claim 1, wherein when in use sound from the voice of the vocalist can travel into the voice tube, out of the mixing chamber, and into an ear canal of the vocalist.

10. The device of claim 9, wherein at least part of the sound escapes from the second opening of the mixing tube prior to entering the ear canal of the vocalist.

11. A device for assisting a vocalist to hear his or her voice, comprising:
a mixing chamber defining a first opening and a second opening, the first opening for positioning relative to an ear of the vocalist and the second opening open to atmosphere;
a main tube coupled to the mixing chamber and defining a main tube opening, the main tube opening located relative to the mixing chamber; and
an extension tube at least partially inserted into the main tube and defining an extension tube opening for positioning relative to a mouth of the vocalist;

12. The device of claim 11, wherein a distance between the main tube opening and the extension tube opening can be changed by changing a relative position of the extension tube within the main tube.

13. The device of claim 11, wherein when a portion of the device is positioned relative to the ear of the vocalist and wherein when the extension tube opening is positioned relative to the mouth of the vocalist, sound from the voice of the vocalist can travel through the extension tube opening of the extension tube, through the extension tube and the main tube and into the mixing chamber, whereby the sound combines with ambient sound from the second opening within the mixing chamber to form a mixed sound, and whereby the mixed sound can travel from the mixing chamber out of the first opening and into an ear canal of the vocalist.

14. The device of claim 11, wherein when in use sound from the voice of the vocalist can travel into the extension tube, into the main tube, out of the mixing chamber, and into an ear canal of the vocalist.

15. The device of claim 11, wherein the extension tube is rotatable within the main tube.

16. The device of claim 11, further comprising:
a friction clip interposed between overlapping areas of the extension tube and the main tube.

17. The device of claim 16, wherein the friction clip slides in frictional engagement within the main tube.

18. The device of claim 11, further comprising:
a voice collector positioned at an end of the extension tube proximate the mouth of the vocalist.

19. A method of directing sound from a voice of a vocalist to an ear of the vocalist, the method comprising the steps of:
wearing a device, the device comprising:
a mixing chamber defining a first opening and a second opening, the first opening for positioning relative to the ear of the vocalist and the second opening open to atmosphere, and
a voice tube extending from proximate a mouth of the vocalist to the mixing chamber and defining a third opening and a fourth opening, the third opening for positioning relative to the mouth and the fourth opening located relative to the mixing chamber; and
generating the sound so that least part of the sound from the voice of the vocalist is directed into the voice tube, into the mixing chamber, and into an ear canal of the vocalist.

20. The method of claim 19, further comprising the step of:
adjusting the voice tube after the step of wearing the device, the step of adjusting performed by moving an extension tube of the voice tube relative to a main tube of the first tube so that the third opening is positioned relative to the mouth of the vocalist.
